(19) United States
(12) Patent Application Publication
(10) Pub. No.: US 2024/0201574 A1
(43) Pub. Date: Jun. 20, 2024

(54) PROJECTION IMAGE APPARATUS

(71) Applicant: Panasonic Intellectual Property Management Co., Ltd., Osaka (JP)

(72) Inventors: Shigekazu Yamagishi, Osaka (JP); Manabu OKUNO, Osaka (JP)

(21) Appl. No.: 18/589,664

(22) Filed: Feb. 28, 2024

Related U.S. Application Data
(63) Continuation of application No. PCT/JP2022/026187, filed on Jun. 30, 2022.

(30) Foreign Application Priority Data
Sep. 9, 2021 (JP) 2021-147075

(51) Int. Cl. G03B 33/08; G03B 21/20

(52) U.S. Cl. CPC G03B 33/08; G03B 21/2013; G03B 21/2033; G03B 21/2066

(57) ABSTRACT

A projection image apparatus includes an illumination optical system generating illumination light by combining laser light of a first and a second color, a light modulator generating image light by modulating the illumination light, and a projection optical system enlarging and projecting the image light. The light source is configured to have a small difference between a height of a light source image of the laser light of the first color and a height of a light source image of the laser light of the second color. The illumination optical system includes a relay optical system including a first diaphragm of reflective type having a variable opening diameter, the first diaphragm disposed at a first pupil position. The projection optical system includes a second diaphragm of absorption type having a variable opening diameter, the second diaphragm disposed at a second pupil position conjugate with the first pupil position.

### 1. TECHNICAL FIELD

The present disclosure relates to a projection image apparatus, and more particularly to a configuration that provides high-contrast image light by converting laser light from a light source into illumination light with a small spread using a diaphragm.

### 2. DESCRIPTION OF THE RELATED ART

With the progress of the solid-state light source technology, the projection image apparatus is replacing a conventional discharge tube lamp as a light source thereof with an LED or a laser having advantages such as a long life, no mercury, and no explosion. In particular, a laser has a small light output from one individual, but has a relatively small etendue of the light output. Therefore, a laser coming in a plurality of array units is used as a light source, and a projector having a high output exceeding 5000 lumens is also commercialized.

A laser unit in which a large number of lasers are two-dimensionally mounted at high density and housed in a package is common. While brightness is being achieved up to a certain value, high contrast of a projection image is being demanded for high image quality.

However, the projection image apparatus is inferior to a self-luminous device in terms of contrast. In order to improve the contrast, it is necessary to achieve illumination with a small spread (illumination with a large F value). However, in the conventional light source, when an illumination system with a large F value is introduced in order to increase the contrast, the light with a large spread is removed from the light from the light source, and the brightness is greatly impaired.

The image display device is small in size and high in definition, but light modulated for each minute pixel interferes with one another, and becomes stray light in the projection optical system, which becomes a cause of impairing contrast. In view of this situation, the following proposals have been conventionally made.

For example, in Patent Literature (PTL) 1, one diaphragm means is arranged in either an illumination optical system or a projection optical system, at least one color light of red, green, and blue has a light distribution characteristic different from that of other color light, and a change in color balance occurs in a finally obtained image that occurs when the diaphragm means performs narrowing, but it is corrected and maintained by modulation of a light source.

In PTL 2, a diaphragm having a variable diaphragm diameter is arranged in each of an illumination optical system and a projection optical system, and the diaphragm ratio of the illumination optical system is larger than the diaphragm ratio of the projection optical system. This aims to obtain an image with high contrast.

PTL 1 is Unexamined Japanese Patent Publication No. 2006-178080.

PTL 2 is Unexamined Japanese Patent Publication No. 2006-285089.

### SUMMARY

In PTL 1, the color of a projection image changes due to a diaphragm change. Although the color change can be suppressed by a light source output change, the entire color change may become at an unacceptable level, and generally, the brightness distribution at the center and the periphery is also changed. Thus, modulation of the light source alone is only a partial improvement.

In PTL 2, contrast can be obtained by providing each of the illumination optical system and the projection optical system with a variable diaphragm. However, a single xenon tube or mercury lamp is used as a light source, and the luminance is easily reduced by the diaphragm of the illumination optical system.

An object of the present disclosure is to provide a projection image apparatus in which a decrease in luminance is suppressed, a color change is suppressed, and contrast is improved.

A projection image apparatus of the present disclosure includes: a light source that emits laser light of a first color that is blue and laser light of a second color different from blue; an illumination optical system that generates illumination light by combining the laser light of the first color and the laser light of the second color from the light source; a light modulator that generates image light by modulating the illumination light from the illumination optical system in response to an image signal input from an outside; and a projection optical system that enlarges the image light emitted from the light modulator and projects the image light onto a projection target. The light source includes a first light source component including a plurality of first laser light emitters arranged in an array, and each configured to emit the laser light of the first color, and a second light source component including a plurality of second laser light emitters arranged in an array, and each configured to emit the laser light of the second color. An area of a light emitting surface of the first light source component is different from an area of a light emitting surface of the second light source component. The illumination optical system includes a relay optical system that guides the illumination light to the light modulator. The light source further includes an optical system that changes at least one of a height of a light source image of the laser light of the first color and a height of a light source image of the laser light of the second color. The optical system of the light source is configured to have a small difference between the height of the light source image of the laser light of the first color and the height of the light source image of the laser light of the second color. The relay optical system includes a reflection first diaphragm of reflection type having a variable opening diameter, the first diaphragm disposed at a first pupil position where the illumination light is condensed. The projection optical system includes a second diaphragm of absorption type having a variable opening diameter, the second diaphragm disposed at a second pupil position conjugate with the first pupil position.

The projection image apparatus of the present disclosure can provide a projection image apparatus in which a decrease in luminance is suppressed, a color change is suppressed, and contrast is improved.

### BRIEF DESCRIPTION OF THE DRAWINGS

FIG. 1 is an overall configuration diagram of a projection image apparatus of an exemplary embodiment.

FIG. 2 is a front view illustrating the shape of blue laser units and shapes of red and green laser units.

FIG. 3 is a front view illustrating an arrangement example of a comparative example of the red and green laser units.

FIG. 4 is an explanatory diagram explaining a light flux distribution obtained in the arrangement example of the comparative example of the red and green laser units.

FIG. 5 is a perspective view illustrating an arrangement example according to the present disclosure of red and green laser units.

FIG. 6 is an explanatory diagram explaining a light flux distribution obtained in the arrangement example according to the present disclosure of the red and green laser units.

FIG. 7 is a perspective view illustrating an arrangement example according to the present disclosure of blue laser units.

FIG. 8 is an explanatory diagram explaining a light flux distribution obtained in the arrangement example according to the present disclosure of the blue laser units.

FIG. 9 is an explanatory diagram explaining a light flux distribution before incidence of an afocal optical system.

FIG. 10 is an explanatory diagram explaining a light flux distribution after emission of an afocal optical system.

FIG. 11 is a perspective view illustrating an example of a configuration of a diaphragm unit.

FIG. 12 is a comparative view of an opening diameter of a diaphragm.

### DETAILED DESCRIPTION

An exemplary embodiment will be described in detail below with reference to the drawings as appropriate. However, descriptions more in detail than necessary may be omitted. For example, the detailed descriptions of already well-known matters and overlapping descriptions of substantially the same configurations may be omitted. This is to avoid an unnecessarily redundant description below and to facilitate understanding of a person skilled in the art.

Note that the inventor(s) provides the accompanying drawings and the following description to help those skilled in the art to sufficiently understand the present disclosure, but does not intend to use them to limit the subject matters of the claims.

### Exemplary Embodiment

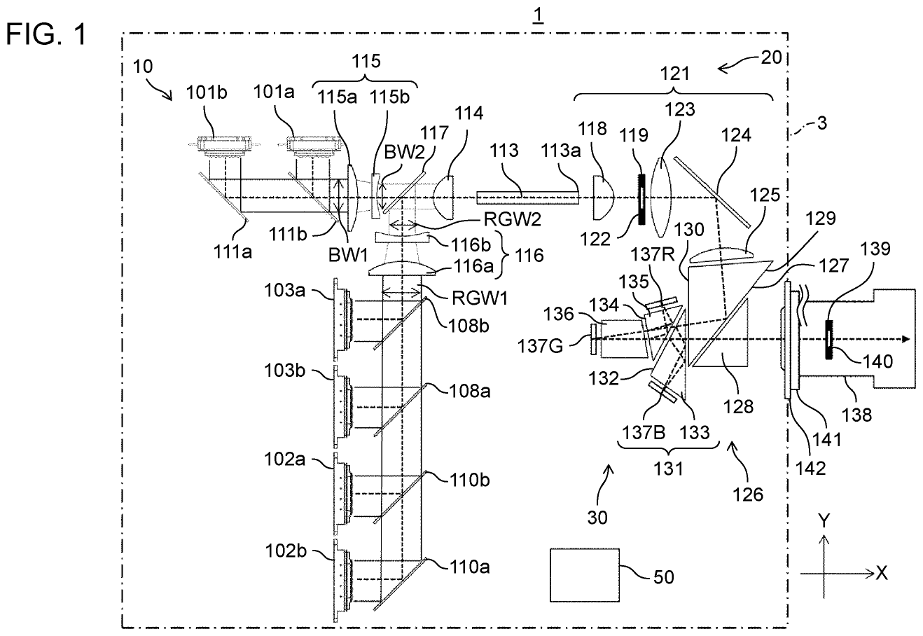

An exemplary embodiment will be described below with reference to FIGS. 1 to 12. First, FIG. 1 will be referred to. FIG. 1 is a configuration diagram of projection image apparatus 1 of a first exemplary embodiment of the present disclosure.

### [1-1. Configuration]

As illustrated in FIG. 1, projection image apparatus 1 includes light source 10, illumination optical system 20, light modulator 30, projection lens unit 138 as a projection optical system, and controller 50. Light source 10 emits laser light of a first color that is blue, laser light of a second color of green, which is different from blue, and laser light of a third color of red, which is different from blue and green. Illumination optical system 20 generates illumination light by combining laser light of blue, laser light of green, and laser light of red from light source 10. Light modulator 30 generates image light by modulating illumination light from illumination optical system 20 in response to an image signal input from an outside. Projection lens unit 138 enlarges and projects, onto a projection target, image light emitted from light modulator 30.

Light source 10 includes blue laser units 101a and 101b that emit laser light of blue (hereinafter, referred to as blue light), green laser units 102a and 102b that emit laser light of green (hereinafter, referred to as green light), and red laser units 103a and 103b that emit laser light of red (hereinafter, referred to as red light). In light source 10, two laser light units that emit laser light of the respective colors are arranged, and light source 10 obtains white light by combining laser light of these colors.

The light sources of the light of the respective colors described above are arranged in an array of combinations in which a lens is placed on the emission side of the laser light source to obtain parallel light. Among them, the blue laser has high luminous efficiency with respect to other color light, it can be configured by a combination of a laser light source in which the number of light emitters is smaller than that of other color light and a lens in order to combine the blue laser with other color light to finally obtain white. This enables a configuration with a package having a small size and can suppress the price to be low.

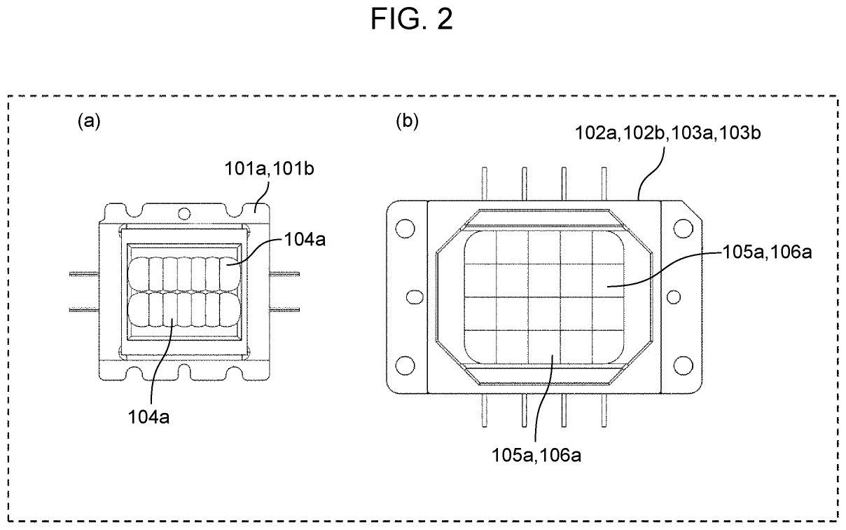

FIG. 2 will be referred to. FIG. 2 is a front view illustrating a light source package, FIG. 2(a) is a front view of blue laser units 101a and 101b, and FIG. 2(b) is a front view of each of green laser units 102a and 102b and red laser units 103a and 103b. In the present exemplary embodiment, as illustrated in FIG. 2(a), blue laser units 101a and 101b in which 14 laser light emitters 104a are arranged are arranged for blue light, and as illustrated in FIG. 2(b), green laser units 102a and 102b and red laser units 103a and 103b in which 20 laser light emitters 105a and 106a are respectively arranged for green light and red light are arranged. Blue laser units 101a and 101b are examples of a first light source component and a fourth light source component, respectively. Green laser units 102a and 102b are examples of a second light source component and a fifth light source component, respectively. Red laser units 103a and 103b are examples of a third light source component and a sixth light source component, respectively.

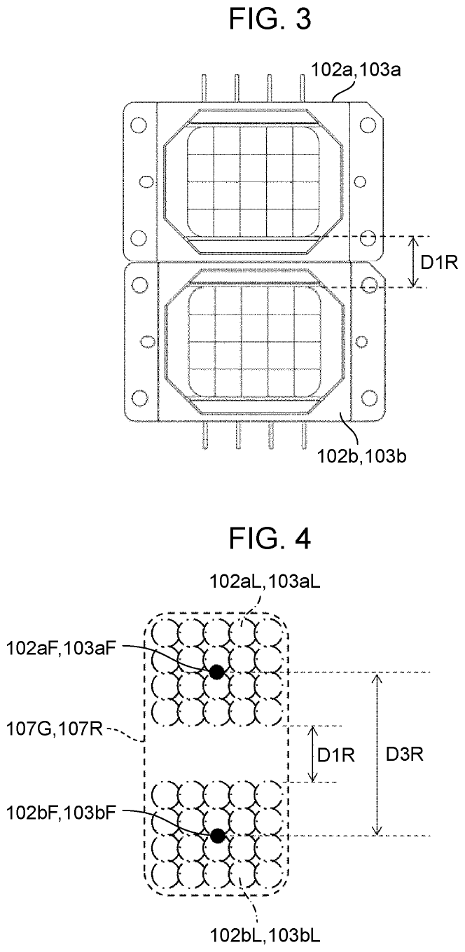

FIGS. 3 and 4 will be referred to. FIG. 3 is a configuration diagram when red laser units or green laser units are planarly placed as a comparative example. FIG. 4 is an arrangement diagram of light fluxes in the case of FIG. 3. In the laser units of each color light, light emitting parts are concentratedly arranged at the center with respect to the outer shape. As illustrated in FIG. 3, in the comparative example, red laser units 103a and 103b are arranged with their outer shapes in contact with each other. Similarly, green laser units 102a and 102b are arranged with their outer shapes in contact with each other.

In practice, planarly arrangement requires longer intervals between the light emitting parts in order to avoid interference of the outer shape of the package, and therefore, conventionally, there are longer intervals between the laser units. In this configuration, as illustrated in FIG. 4, when described using red as an example, an interval by distance D1R is provided between light fluxes 103aL and 103bL from red laser units 103a and 103b. That is, as a light source, a light flux in which distance D1R is included in light fluxes 103aL and 103bL is treated as red light flux 107R. In green, similarly, an interval by distance D1R is provided between light fluxes 102aL and 102bL from green laser units 102a and 102b, and, as a light source, a light flux in which distance D1R is included in light fluxes 102aL and 102bL is treated as green light flux 107G.

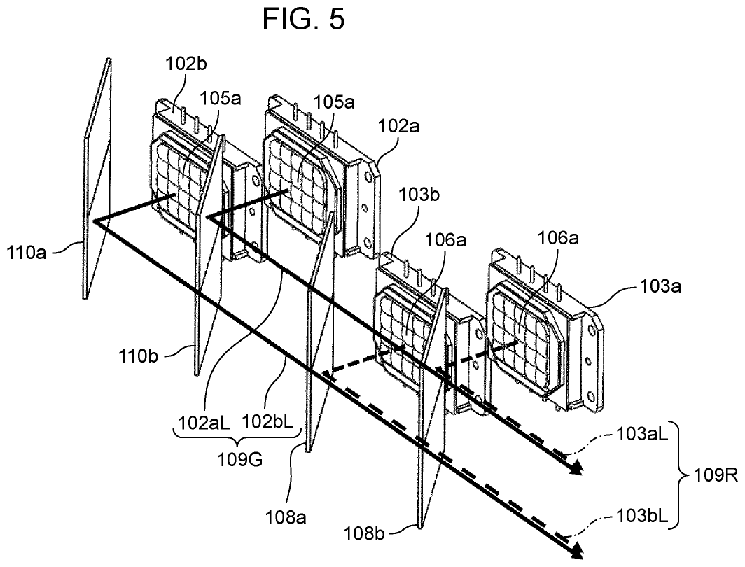

On the other hand, in the present exemplary embodiment, light fluxes from the light source are combined via a mirror as in FIG. 5. FIG. 5 is an arrangement of red and green laser units according to the present disclosure.

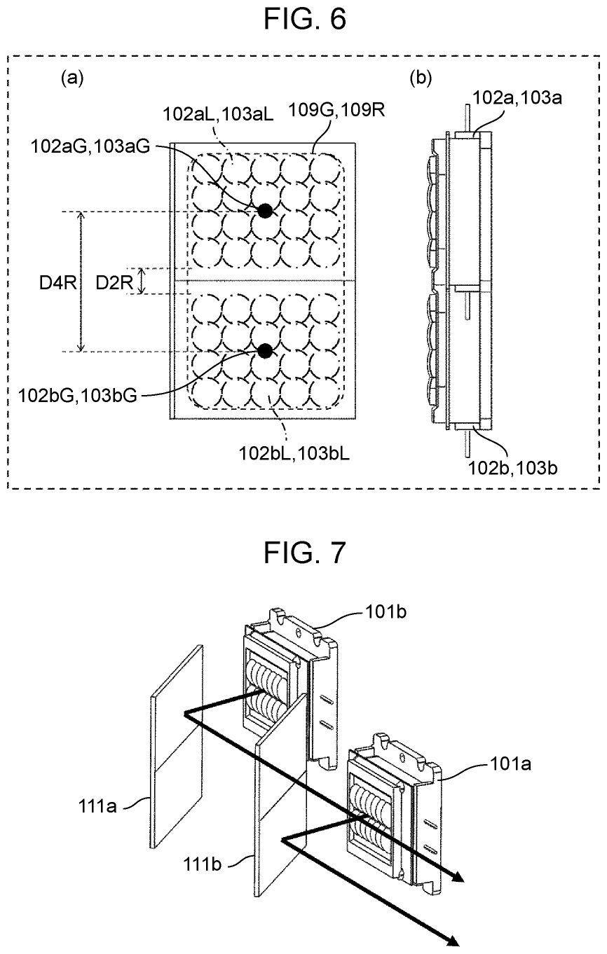

Light flux 103aL from red laser unit 103a and light flux 103bL from red laser unit 103b are reflected by mirrors 108a and 108b, respectively, and are emitted from light source 10 as one red light flux 109R. Mirrors 108a and 108b are, for example, dichroic mirrors. In mirror 108a, a thin film that reflects red light is formed in a lower half region. Mirror 108b has the same mirror disposed upside down and a characteristic of reflecting red light incident on an upper half region. With mirrors 108a and 108b arranged, red laser unit 103a and red laser unit 103b can be arranged to have the respective outer shapes overlap each other in front view or side view (see FIG. 6(b)) and have arrangement regions of laser light emitters 106a do not overlap each other, and the magnitude of one combined light flux 107R can be reduced. Mirror 108b is an example of a third mirror. Mirror 108a is an example of a sixth mirror.

Light flux 102aL from green laser unit 102a and light flux 102bL from green laser unit 102b are reflected by mirrors 110a and 110b, respectively, and are emitted from light source 10 as one green light flux 109G. Mirrors 110a and 110b are partial mirrors having characteristic on each one of the upper and lower sides of the reflection surface, for example. For example, in mirror 110a, surface is formed in a lower half region. Mirror 110b has the same mirror disposed upside down and surface is formed in an upper half region. With mirrors 110a and 110b arranged, green laser unit 102a and green laser unit 102b can be arranged to have the respective outer shapes overlap each other in front view or side view (see FIG. 6(b)) and have arrangement regions of laser light emitters 105a do not overlap each other, and the magnitude of one combined green light flux 109G can be reduced. Mirror 110b is an example of a second mirror. Mirror 110a is an example of a fifth mirror.

Due to this, regarding light source light after reflected by each mirror, as illustrated in FIG. 6 in which optical paths reflected by mirrors 108a and 108b are viewed from the −Y direction in FIG. 1, the light fluxes from the light source can be arrayed at intervals with distance D2R sufficiently smaller than distance D1R (FIG. 4). FIG. 6 is an explanatory diagram explaining the light flux distribution obtained in the arrangement example according to the present disclosure of the red and green laser units. FIG. 6(a) is a front view illustrating a light flux distribution obtained in the arrangement example according to the present disclosure of the red and green laser units, and FIG. 6(b) is a side view of the red and green laser units.

Red light flux 109R formed across distance D2R can emit light having the same output with a light flux smaller than red light flux 107R including distance D1R. Therefore, interval D4R between centroid position 103aG of light flux 103aL from red laser unit 103a and centroid position 103bG of light flux 103bL from red laser unit 103b finally emitted from light source 10 is shorter than interval D3R between centroid position 103aF (see FIG. 4) of each light flux 103aL and centroid position 103bF of light flux 103bL formed by arranging the outer shape of red laser unit 103a and the outer shape of red laser unit 103b in contact with each other in the interval direction. This can convert red light into a light flux having a high light density. That is, interval D4R between the centroid position of the light flux of the red laser light reflected by mirror 108b and the centroid position of the light flux of the red laser light reflected by mirror 108a is shorter than interval D3R between the center position (centroid position 103aF) of red laser unit 103a and the center position (centroid position 103bF) of red laser unit 103b when the outer shape of red laser unit 103a and the outer shape of red laser unit 103b are arranged in contact with each other.

Similarly to red light, green light flux 109G formed across distance D2R can emit light of the same output with a light flux smaller than the green light flux including distance D1R. Therefore, interval D4R between centroid position 102aF of light flux 102aL from green laser unit 102a and centroid position 102bG of light flux 102bL from green laser unit 102b finally emitted from light source 10 is shorter than interval D3R between centroid position 102aF (see FIG. 4) of each light flux 102aL and centroid position 102bF of light flux 102bL formed by arranging the outer shape of green laser unit 102a and the outer shape of green laser unit 102b in contact with each other in the interval direction. This can also convert green light into a light flux having a high light density. That is, interval D4R between the centroid position of the light flux of the green laser light reflected by mirror 110b and the centroid position of the light flux of the green laser light reflected by mirror 110a is shorter than interval D3R between the center position (centroid position 102aF) of green laser unit 102a and the center position (centroid position 102bF) of green laser unit 102b when the outer shape of green laser unit 102a and the outer shape of green laser unit 102b are arranged in contact with each other.

As illustrated in FIG. 5, green laser units 102a and 102b have the same size as red laser units 103a and 103b, for example, and mirrors 110a and 110b having characteristic on one of the upper and lower sides of the reflection surface are arranged on the same optical path, and therefore the light reflected by mirrors 110a and 110b passes through mirrors 108a and 108b, which are red reflection dichroic mirrors, and the green source light flux obtained is configured to be superimposed on red light flux 109R.

Although the shapes, sizes, and orientations of the laser units are different between the blue light and the red light, when the laser units are arranged on the same plane as conventionally, an interval between the laser units increases in order to avoid interference between light source packages. Also in blue light, similarly to red light and green light, a small blue light flux can be achieved by combining the blue light with mirrors 111a and 111b having reflection characteristics only on any of the upper and lower sides. Mirror 111b is an example of a first mirror. Mirror 111a is an example of a fourth mirror.

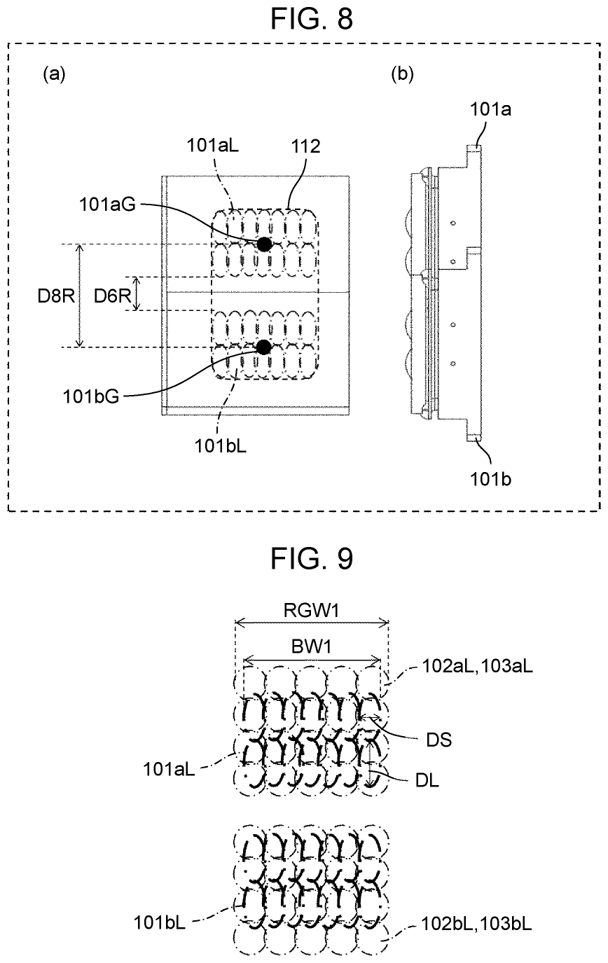

FIG. 7 is a perspective view illustrating an arrangement example according to the present disclosure of the blue laser light source. FIG. 8 is an explanatory diagram explaining the light flux distribution obtained in the arrangement example according to the present disclosure of the blue laser units. FIG. 8(a) is a front view illustrating a light flux distribution obtained in the arrangement example according to the present disclosure of the blue laser unit, and FIG. 8(b) is a side view of the blue laser unit. Thus, FIG. 7 illustrates an arrangement example of the blue light source package and the mirror, and FIG. 8 illustrates a combined light source light flux.

Similarly to red light, light source light flux 112 of blue formed across distance D6R can emit light of the same output with a light flux smaller than the blue light flux including light fluxes 101aL and 101bL from the two blue laser units 101a and 101b arranged with the outer shapes thereof in contact with each other. Therefore, similarly to the red light and the green light, interval D8R between centroid position 101aG of light flux 101aL from blue laser unit 101a and centroid position 101bG of light flux 101bL from blue laser unit 101b finally emitted from light source 10 is shorter than an interval between the centroid position of each light flux 101aL and the centroid position of light flux 102bL formed by arranging the outer shape of blue laser unit 101a and the outer shape of blue laser unit 101b in contact with each other in the interval direction. This can also convert blue light into a light flux having a high light density. That is, interval D8R between the centroid position of the light flux of the laser light of blue reflected by mirror 111b and the centroid position of the light flux of the laser light of blue reflected by mirror 111a is shorter than the interval between the center position of blue laser unit 101a and the center position of blue laser unit 101b when the outer shape of blue laser unit 101a and the outer shape of blue laser unit 101b are arranged in contact with each other.

In FIGS. 1 and 7, since there is no light transmitted through mirrors 110a and 111a, mirrors that reflect all normal visible light may be adopted, and for the same reason, mirrors 110b and 111b may be mirrors that partially reflect all visible light.

Illumination optical system 20 uses laser light from red laser units 103a and 103b and green laser units 102a and 102b illustrated in FIG. 5 and blue laser units 101a and 101b illustrated in FIG. 7. However, since light source light fluxes 109 of red and green and light source light flux 112 of blue are different in size, if they are combined as they are, the light beam heights incident on condenser lens 114 that condenses light to rod integrator 113 are different. Due to this, since red and green laser light are incident on rod integrator 113 at a larger angle than blue laser light, a strong image of red and green is obtained in a peripheral part than in the center part in a projection image, which causes color unevenness.

Therefore, in the present exemplary embodiment, light source 10 includes blue afocal optical system 115 and red and green afocal optical system 116 that equalize the heights of light fluxes of blue, red, and green. Blue afocal optical system 115 includes convex lens 115a and concave lens 115b. Red and green afocal optical system 116 includes convex lens 116a and concave lens 116b. Blue light emitted from blue afocal optical system 115 and red light and green light emitted from red and green afocal optical system 116 are combined by blue transmissive dichroic mirror 117 and are incident on condenser lens 114.

FIG. 9 will be referred to. FIG. 9 is an explanatory diagram explaining a light flux distribution before being incident on the afocal optical system. Here, the height of a light flux (light source image) may be a length in the width direction that is short diameter DS direction of each laser light constituting light fluxes 101aL and 101bL of the laser light of blue, or may be a length in long diameter DL direction. Hereinafter, an example in which the length in the width direction of the light flux is equalized as the height of the light flux will be described. Here, the width of the light flux incident on blue afocal optical system 115 is BW1, the width of the light flux emitted through blue afocal optical system 115 is BW2, and the magnification of blue afocal optical system 115 is BW2/BW1. That is, blue afocal optical system 115 (an example of the first afocal optical system) changes width BW1 (the height of the light source image of the laser light of blue) to width BW2 (the first height).

Similarly, the width of the light flux incident on red and green afocal optical system 116 is RGW1, the width of the light flux emitted through red and green afocal optical system 116 is RGW2, and the magnification of red and green afocal optical system 116 is RGW2/RGW1. That is, red and green afocal optical system 116 (an example of the second afocal optical system) changes width RGW1 (the height of the light source image of the laser light of green) to width RGW2 (the second height). Red and green afocal optical system 116 (an example of the second afocal optical system) changes width RGW1 (the height of the light source image of the laser light) of red to width RGW2 (the second height). Here, the height of the light source of the laser light of green emitted through red and green afocal optical system 116 is not necessarily the same as the height of the light source of the laser light of red emitted through red and green afocal optical system 116, and they may be different from each other. Note that blue afocal optical system 115 and red and green afocal optical system 116 are examples of the optical system of light source 10.

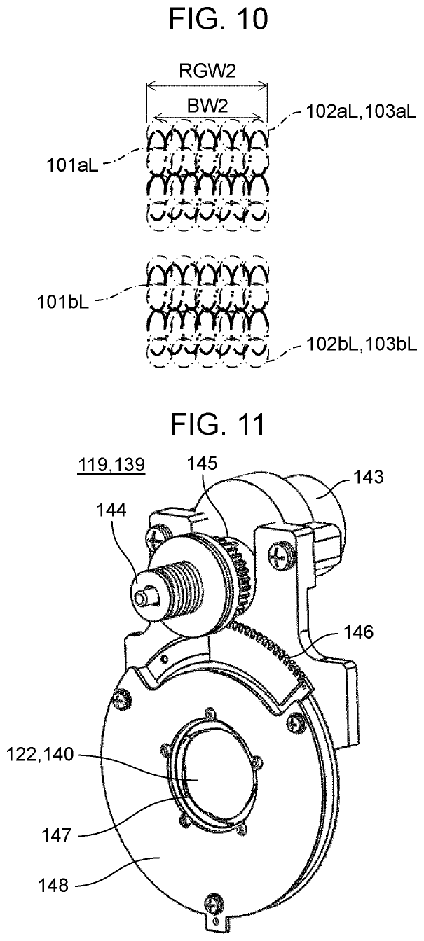

FIG. 10 will be referred to. FIG. 10 is an explanatory diagram explaining a light flux distribution after emission of the afocal optical system. At this time, when the light beam height incident on condenser lens 114 is to be matched, BW2=RGW2, and on the other hand, since BW1<RGW1, blue afocal optical system 115 and red and green afocal optical system 116 are different in magnification. As described above, the magnifications of blue afocal optical system 115 and red and green afocal optical system 116 are different to make width BW2 of the images of light fluxes 101aL and 101bL of the laser light of blue and width RGW2 of the images of light fluxes 102aL, 102bL, 103aL, and 103bL of the laser light of green and red equal to width BW1 of the images of light fluxes 101aL and 101bL and width RGW1 of the images of light fluxes 102aL, 102bL, 103aL, and 103bL at the time of respective emission. However, the matching in the width direction here is an example, and depending on the light amount distribution of each light source and the overall optical characteristics, matching may be performed in long diameter DL direction of the laser light, matching may be performed in both short diameter DS direction and long diameter DL direction of the laser light, or matching may be performed to make the light flux of blue spreads more than the light fluxes of red and green in short diameter DS direction of the laser light and the light fluxes of red and green spread more than the light flux of blue in long diameter DL direction. As described above, blue afocal optical system 115 and red and green afocal optical system 116 are configured to have a small difference between width BW2 and width RGW2. More specifically, blue afocal optical system 115 and red and green afocal optical system 116 are configured to have a difference between width BW2 and width RGW2 that is smaller than a difference between width BW1 and width RGW1. Here, each of the difference between width BW2 and width RGW2 and the difference between width BW1 and width RGW1 means an absolute value of the difference.

In particular, the reduction ratio of the width of the light flux is larger in red and green afocal optical system 116. Note that in a case where the blue light source is further smaller or in a case where condenser lens 114 is larger and BW1=BW2 is satisfied, blue afocal optical system 115 is unnecessary, but the magnification of red and green afocal optical system 116 is smaller than this. FIG. 10 is a view in which magnifications of blue light, and red and green light are superimposed in combination. As described above, illumination optical system 20 includes blue afocal optical system 115 and red and green afocal optical system 116 having different magnifications.

Note that light source 10 need not necessarily include both blue afocal optical system 115 and red and green afocal optical system 116. In one example, light source 10 includes blue afocal optical system 115 and does not include red and green afocal optical system 116. In this case, since light source 10 does not include red and green afocal optical system 116, width RGW1 becomes equal to width RGW2. Blue afocal optical system 115 is configured to have a difference between width BW2 and width RGW2 smaller than a difference between width BW1 and width RGW1. Specifically, by enlarging width BW1 to width BW2, blue afocal optical system 115 reduces the difference between width BW2 and width RGW2. In another example, light source 10 does not include blue afocal optical system 115, but includes red and green afocal optical system 116. In this case, since light source 10 does not include blue afocal optical system 115, width BW1 becomes equal to width BW2. Red and green afocal optical system 116 is configured to have a difference between width BW2 and width RGW2 smaller than a difference between width BW1 and width RGW1. Specifically, by reducing width RGW1 to width RGW2, red and green afocal optical system 116 reduces the difference between width BW2 and width RGW2.

Illumination optical system 20 includes rod integrator 113 and relay optical system 121. Relay optical system 121 includes lens 118, illumination diaphragm unit 119, lens 123, folding mirror 124, and field lens 125.

The light incident on rod integrator 113 is multiple-reflected in rod integrator 113, and then reaches illumination diaphragm unit 119 via lens 118. Illumination diaphragm unit 119 is arranged at a position where a light source image is formed by lens 118 or in the vicinity thereof. This position becomes the first pupil position of relay optical system 121 that transfers the image from emission port 113a of rod integrator 113 onto an image display element.

The light transmitted through opening 122 of illumination diaphragm unit 119 passes through lens 123 and is reflected by folding mirror 124, and then enters total reflection prism 126 through field lens 125.

Light modulator 30 includes total reflection prism 126, color prism unit 131, and light modulation elements 137R, 137G, and 137B.

Total reflection prism 126 is formed by fixing first prism 127 and second prism 128 while maintaining a slight gap (air gap). The light incident on total reflection prism 126 is totally reflected by total reflection surface 129, and then enters color prism unit 131 through surface 130.

Color prism unit 131 is configured by bonding and fixing first prism 133 including blue transmissive dichroic mirror surface 132 having a characteristic of reflecting blue light, second prism 135 including green transmissive dichroic mirror surface 134 having a characteristic of reflecting red light and blue light, and third prism 136. However, an air gap is provided between first prism 133 and second prism 135 in order to use total reflection.

As illustrated in FIG. 1, light modulation elements 137R, 137G, and 137B are disposed to face end surfaces of the respective prisms. These light modulation elements are, for example, DMDs in which minute mirrors are two-dimensionally arranged. A tilt direction of a micro mirror is controlled in two directions in accordance with a video signal input from the outside via controller 50. The reflected light reflected by the micro mirror at the tilt angle at the time of an ON signal returns to color prism unit 131 at an incident angle of 0°. The reflected light reflected by the micro mirror at the tilt angle at the time of an OFF signal is incident on color prism unit 131 again at a large angle with respect to color prism unit 131. Light modulation element 137B is for blue light modulation, light modulation element 137R is for red light modulation, and light modulation element 137G is for green light modulation.

In each pixel of light modulation elements 137R, 137G, and 137B, those in a white display mode return to color prism unit 131 again, pass through here, is transmitted through second prism 128 and first prism 127 of total reflection prism 126, and is incident on projection lens unit 138.

Projection diaphragm unit 139 is disposed at the second pupil position of projection lens unit 138. The first pupil position where illumination diaphragm unit 119 is disposed and the second pupil position where projection lens unit 138 is disposed are conjugate with each other. The light incident on projection lens unit 138 passes through opening 140 and reaches a screen as a projection target not illustrated. Projection lens unit 138 is detachably fixed to mount member 142 provided in the housing of a body of projection image apparatus 1, which is not illustrated, via projection lens flange 141. Such configuration of the fixing portion can be formed of bayonet or the like. In this way, by inputting different signals in response to image signals to light modulation elements 137R, 137G, and 137B, color display can be achieved on the screen.

Illumination diaphragm unit 119 includes a plurality of blade members having a high reflection characteristic on a surface thereof and a diffusion characteristic. The diffuse reflection of illumination diaphragm unit 119 is formed by satin treatment of the surface or stucco pattern treatment in which many irregularities are randomly arranged. Due to this, even if strong light is received, heat generation of the diaphragm itself can be suppressed, and the reflected light can be condensed at an arbitrary position by being diffused to suppress heat generation and burning of other members.

However, heat absorption occurs even in a highly reflective material, and therefore occurrence of burning or the like is suppressed by using a material having excellent thermal conductivity such as aluminum or copper. As described above, illumination diaphragm unit 119 of illumination optical system 20 includes a plurality of movable blade members made of a material subjected to high thermal conduction and high reflection treatment, and the surface thereof is a diffuse reflection surface. In one example, the plurality of blade members mainly diffuse and reflect 70% or more of light incident on the plurality of blade members. In another example, the plurality of blade members diffuse and reflect 80% or more of light incident on the plurality of blade members.

These diaphragms are driven by an actuator coupled via a cam under the control of controller 50 of body 3, and are configured to arbitrarily set the opening diameter of opening 122 of illumination diaphragm unit 119. An example of a specific structure of illumination diaphragm unit 119 is illustrated in FIG. 11. FIG. 11 is a perspective view illustrating an example of the configurations of illumination diaphragm unit 119 and projection lens unit 138.

Illumination diaphragm unit 119 includes stepping motor 143 as an actuator, slip clutch 144 on an output shaft thereof, and gear 145 to be coupled, and is coupled to fan gear 146 to extend from a cam of a diaphragm not illustrated, whereby the plurality of diaphragm blades 147 are moved according to the rotation amount of stepping motor 143, and due to this, the diaphragm diameter of opening 122 can be controlled. The incident side includes front plate 148 made of a highly reflective aluminum material. Front plate 148 may also be subjected to light diffusion treatment.

Similarly, in projection diaphragm unit 139 of projection lens unit 138, the plurality of diaphragm blades 147 are driven via the cam, and the diameter of opening 140 is made variable by control from the body side. Unlike illumination diaphragm unit 119, the surface treatment of diaphragm blades 147 of projection lens unit 138 is performed with heat-resistant black color treatment. This suppresses generation of stray light in projection lens unit 138. As described above, projection diaphragm unit 139 includes the material subjected to the light absorption treatment, and includes the plurality of movable diaphragm blades 147. In one example, the plurality of diaphragm blades 147 absorb 90% or more of visible light incident on the plurality of diaphragm blades 147. In another example, the plurality of diaphragm blades 147 absorb 95% or more of visible light incident on the plurality of diaphragm blades 147. Note that between the F number of illumination optical system 20 determined by illumination diaphragm unit 119 and the F number of projection lens unit 138 (projection optical system) determined by projection diaphragm unit 139, a relationship is always maintained in which the F number of illumination optical system 20 is equal to or greater than the F number of projection lens unit 138, and thus, a heat load on projection diaphragm unit 139 can be suppressed.

### Illumination Optical System F Number≥Projection Optical System F Number

Note that projection lens unit 138 has an interchangeable lens system that is interchangeable as described above. Therefore, when projection lens unit 138 is detached from body 3 of projection image apparatus 1 or is mounted on a body other than body 3 that satisfies the function of the present disclosure, the diameter of the diaphragm of projection diaphragm unit 139 is brought into a first state of being set to first opening diameter PD1. That is, when projection lens unit 138 is detached from body 3 of projection image apparatus 1 and is in a state of being not controlled from the outside, the diameter of the diaphragm of projection diaphragm unit 139 is set to first opening diameter PD1. The diameter of the diaphragm of projection diaphragm unit 139 in a case of being mounted on body 3 satisfying the function of the present disclosure is brought into a second state of being set to second opening diameter PD2, and the diameter of the diaphragm of projection diaphragm unit 139 in a case of being mounted on body 3 satisfying the function of the present disclosure and controlled to be narrowed becomes third opening diameter PD3. First opening diameter PD1, second opening diameter PD2, and third opening diameter PD3 are configured to satisfy the following relationship.

### First Opening Diameter PD1>Second Opening Diameter PD2>Third Opening Diameter PD3

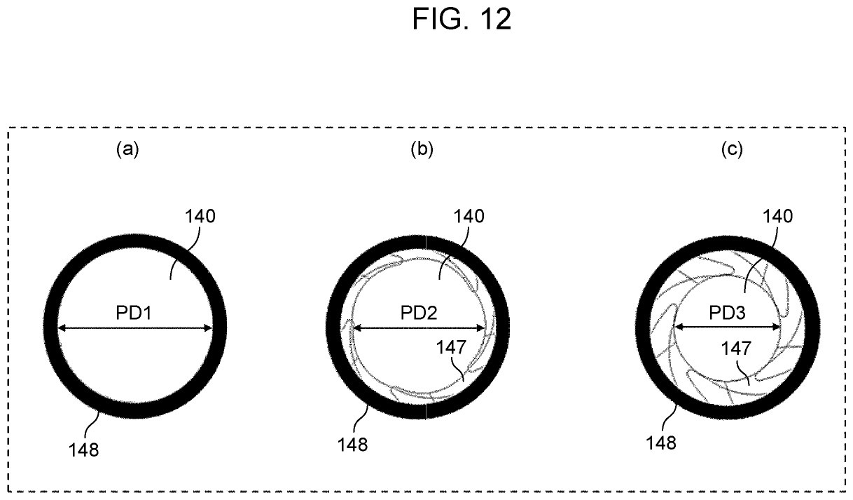

FIG. 12 is a comparative diagram of the opening diameter of the diaphragm. FIG. 12(a) is an explanatory diagram illustrating first opening diameter PD1 in the first state, FIG. 12(b) is an explanatory diagram illustrating second opening diameter PD2 in the second state, and FIG. 12(c) is an explanatory diagram illustrating third opening diameter PD3 in the third state. Note that first opening diameter PD1 in the first state and second opening diameter PD2 in the second state have predetermined sizes, and third opening diameter PD3 can be set to any size from the second state to the third state under the control of controller 50 in body 3. By further narrowing the diameter of the diaphragm of projection diaphragm unit 139 from the second state, the contrast can be increased although the light amount to be projected is reduced. Therefore, in a case where the contrast is desired from the second state depending on the usage of projection image apparatus 1 such as the projection size and the surrounding brightness, third opening diameter PD3 can be set to an arbitrary size, whereby a desired contrast can be obtained. That is, projection diaphragm unit 139 is configured to be brought into the third state of being set to third opening diameter PD3 smaller than second opening diameter PD2 from the second state. Third opening diameter PD3 is set to an arbitrary size smaller than second opening diameter PD2 under the control of controller 50 in body 3.

As described above, when projection lens unit 138 is mounted on a projector body not according to the present disclosure, in a case where illumination diaphragm unit 119 is not provided, if image light is directly irradiated, the blade of projection diaphragm unit 139 may be damaged by heat. In a case where of being mounted on body 3 that satisfies the function of the present disclosure, illumination diaphragm unit 119 has narrowed the illumination light, and therefore, even second opening diameter PD2 smaller than first opening diameter PD1 can prevent the blade of projection diaphragm unit 139 from being damaged by heat. Therefore, first opening diameter PD1 and second opening diameter PD2 have the above-described relationship. That is, projection diaphragm unit 139 is configured to have first opening diameter PD1 in the first state always larger than second opening diameter PD2 in the second state.

Between set body 3 and projection lens unit 138, and between the mount member 142 and projection lens flange 141 of projection lens unit 138, in the case of the set according to the present disclosure, the shift to second opening diameter PD2 is performed by mechanical or electrical action at the time of mounting, and in the case of another set, first opening diameter PD1 is maintained because there is no action at the time of mounting.

For detection of attachment and detachment of body 3 and projection lens unit 138 and diaphragm driving, as described above, both body 3 and projection lens unit 138 may be provided with electrical contact for driving, or a mechanism structure that acts only when body 3 that satisfies the function of the present disclosure is mounted may be provided. In that case, the present invention can be embodied by enabling projection diaphragm driving. Note that the basic structure of projection diaphragm unit 139 is the same as that of illumination diaphragm unit 119, but since it is necessary to store the projection diaphragm unit in projection lens unit 138, a smaller actuator may be used, and the coupled gears may also be configured in a small array following an annular shape.

As described above, in a state where projection lens unit 138 is mounted on projection image apparatus 1, projection lens unit 138 can set the opening diameter of projection diaphragm unit 139 by mechanical operation control or electrical operation control from body 3 of projection image apparatus 1.

### [1-2. Effects or the Like]

As described above, projection image apparatus 1 according to the present exemplary embodiment includes light source 10 that emits laser light of a first color that is blue and laser light of a second color that is green, which is different from blue, illumination optical system 20 that generates illumination light by combining the laser light of the first color and the laser light of the second color from light source 10, light modulator 30 that generates image light by modulating illumination light from illumination optical system 20 in response to an image signal input from the outside, and projection lens unit 138 that enlarges and projects, onto a projection target, image light emitted from light modulator 30. Light source 10 includes blue laser units 101a and 101b in which a plurality of blue laser light emitters that respectively emit laser light of blue are arranged in an array, green laser units 102a and 102b in which a plurality of green laser light emitters that respectively emit green laser light are arranged in an array, and red laser units 103a and 103b in which a plurality of red laser light emitters that respectively emit red laser light are arranged in an array. The area of the light emitting surface of blue laser units 101a and 101b is different from the area of the light emitting surface of green laser units 102a and 102b and red laser units 103a and 103b. Illumination optical system 20 includes relay optical system 121 that guides illumination light to light modulator 30. Relay optical system 121 includes, at the first pupil position where illumination light is collected, blue afocal optical system 115 and red and green afocal optical system 116 having different magnifications according to laser light of blue, green, and red, respectively, to equalize the heights of the light source images of laser light of blue, green, and red to the heights at the time of emission from the respective laser units. Relay optical system 121 includes illumination diaphragm unit 119 of reflective type having a variable opening diameter at the first pupil position. Projection lens unit 138 includes projection diaphragm unit 139 of absorption type having a variable opening diameter at the second pupil position conjugate with the first pupil position.

The above-described configuration achieves illumination with a high F number, the projection lens unit makes the entire projection area white and black and achieves a contrast that is a brightness ratio and a high contrast also by a window contrast of performing black display of a small area in a white screen. In particular, in the latter, reflected light and stray light in the projection optical system, particularly in projection lens unit 138 cause deterioration, and thus excellent performance can be obtained as compared with the conventional system. Note that in the present disclosure, since light source 10 has a small spread of light by a laser, it is possible to minimize the spread of illumination light in illumination optical system 20, and the brightness is less likely to decrease even with a high F number by illumination diaphragm unit 119 and projection diaphragm unit 139 as compared with the conventional system. Furthermore, since relay optical system 121 includes afocal optical systems 115 and 116 having different magnifications, the intensity distribution in the pupil in illumination optical system 20 for each color light is substantially the same, and therefore, even when illumination diaphragm unit 119 further narrows opening 122 in conjunction with projection diaphragm unit 139 of projection lens unit 138 to obtain higher contrast, it is possible to provide an image without color change without changing the balance between the colors.

The area of the light emitting surface of blue laser units 101a and 101b is different from and smaller than the area of the light emitting surface of green laser units 102a and 102b and red laser units 103a and 103b. Due to this, the light amount of blue is concentrated on the center region, and if combined with the laser light of green and red as it is, the center region of the combined light becomes bluish, and the peripheral region becomes insufficient in blue. In this state, when the illumination light is narrowed by illumination diaphragm unit 119 and the image light is narrowed by projection diaphragm unit 139, the color may change due to vignetting of surrounding light depending on a diaphragm level. On the other hand, since the optical system having different magnifications according to the respective laser light is provided to equalize the heights of the light source images of laser light of blue, green, and red to the heights at the time of emission from the respective laser units, it is possible to reduce the concentration of the amount of blue light on the center region and to reduce the color change due to vignetting of light. Here, “to equalize the heights of the light source images of laser light of blue, green, and red to the heights at the time of emission from the respective laser units” includes not only a case where the heights are completely equalized but also a case where the heights are closer than the heights at the time of emission from the respective laser units.

### Other Exemplary Embodiments

As described above, the above exemplary embodiment has been described as an example of the technique disclosed in the present application. However, the technique in the present disclosure is not limited to the above exemplary embodiment, and can also be applied to exemplary embodiments in which change, substitution, addition, omission, and the like are performed. The components described in the above exemplary embodiment can be combined to make a new exemplary embodiment.

In the exemplary embodiment, in the present exemplary embodiment, light fluxes of respective color light are arranged at a high density by devising the arrangement of the laser unit and the mirror that are light sources. However, the means is not limited to this, and even if a prism is used, the same effect can be expected as long as the light source image size (light flux height from the optical axis) finally obtained by changing the afocal optical diameter magnification by the color light is converted to a close value.

In the exemplary embodiment, light modulator 30 is a system including three DMD devices as light modulation elements, but can be applied to a one-chip system using one DMD or a system using three LCD panels. However, in the main stream of the LCD panel system, the integrator includes a microlens array, but at this time, the same effect can be obtained by placing an illumination diaphragm in the vicinity of the microlens array on the emission side as a pupil position.

In the exemplary embodiment, light source 10 includes the blue laser unit, the green laser unit, and the red laser unit, and emits blue laser light, green laser light, and red laser light, respectively, but is not limited to this. Light source 10 may include a blue laser unit and a green laser unit, or a blue laser unit and a red laser unit, and may be configured to emit laser light of two colors.

As described above, the exemplary embodiments have been described as an example of the technique in the present disclosure. For that purpose, the accompanying drawings and the detailed description have been provided. Therefore, the components described in the accompanying drawings and in the detailed description not only include the components essential for solving the problem but also include, in order to exemplify the above technique, components that are not essential for solving the problem. For this reason, it should not be immediately construed that those non-essential components are essential only based on the fact that those non-essential components are illustrated in the accompanying drawings or described in the detailed description.

The above exemplary embodiments are provided to exemplify the technique in the present disclosure, and therefore, it is possible to make various changes, replacements, additions, omissions, and the like within the scope of the claims and equivalents thereof.

### Overview of Exemplary Embodiments

(1) A projection image apparatus of the present disclosure includes: a light source that emits laser light of a first color that is blue and laser light of a second color different from blue; an illumination optical system that generates illumination light by combining the laser light of the first color and the laser light of the second color from the light source; a light modulator that generates image light by modulating the illumination light from the illumination optical system in response to an image signal input from an outside; and a projection optical system that enlarges and projects, onto a projection target, the image light emitted from the light modulator. The light source includes a first light source component including a plurality of first laser light emitters arranged in an array, and each configured to emit the laser light of the first color, and a second light source component including a plurality of second laser light emitters arranged in an array, and each configured to emit the laser light of the second color. An area of a light emitting surface of the first light source component is different from an area of a light emitting surface of the second light source component. The illumination optical system includes a relay optical system that guides the illumination light to the light modulator. The relay optical system includes optical systems having different magnifications according to the laser light of the first color and the second color to equalize the heights of the light source images of the laser light of the first color and the second color to the heights at the time of emission at a first pupil position where the illumination light is condensed. The relay optical system includes a first diaphragm of reflection type having a variable opening diameter at the first pupil position. The projection optical system includes a second diaphragm of absorption type having a variable opening diameter at the second pupil position conjugate with the first pupil position.

This can achieve high contrast, and can reduce reflected light and stray light in the projection optical system. Furthermore, since the light source is a laser with a small spread, the spread of the illumination light in the illumination optical system can be minimized, and the brightness is less likely to decrease even with a higher F number than in the conventional system. Furthermore, since the relay optical system includes optical systems of different magnifications, the intensity distribution in the pupil in the illumination optical system for each color light is also substantially the same. Therefore, even when the illumination diaphragm is further narrowed in conjunction with the diaphragm of the projection lens unit to obtain higher contrast, the balance between the colors does not change, and an image without color change can be provided.
(2) In the projection image apparatus of (1), the light source emits laser light of a third color different from the first color and the second color, and the illumination optical system generates the illumination light by combining the laser light of the first color, the laser light of the second color, and the laser light of the third color. The light source further includes a third light source component including a plurality of third laser light emitters arranged in an array, and each configured to emit the laser light of the third color. The area of the light emitting surface of the first light source component is different from an area of a light emitting surface of at least any of the second light source component and the third light source component. In the optical system of the relay optical system, the magnification of the laser light of at least the first color is different from the laser light magnification of each of the second color and the third color to equalize the heights of the light source images of the laser light of the first color, the second color, and the third color to the heights at the time of emission at the first pupil position where the illumination light is condensed.
(3) In the projection image apparatus of (1) or (2), the projection optical system is a projection lens unit detachably attached to a body of the projection image apparatus. The projection lens unit includes the second diaphragm, and in a case where the second diaphragm is not controlled from the outside, the second diaphragm is brought into a first state of being set to a first opening diameter, and in a case where the projection lens unit is mounted on a predetermined projector, the second diaphragm is brought into a second state of being set to a second opening diameter. The respective opening diameters of the second diaphragm in the first state and the second state are always controlled to satisfy the opening diameter in the first state>the opening diameter in the second state of the diaphragm.
(4) In the projection image apparatus of (3), in a state where the projection lens unit is mounted on the predetermined projection image apparatus, the second diaphragm of the projection lens unit can be changed to a third state in which the second diaphragm is set to a third opening diameter under the control of the body of the projection image apparatus in addition to the second state in which the second diaphragm is set to the second opening diameter. The respective opening diameters of the second diaphragm in the first, second, and third states have a relationship of the opening diameter in the first state>the opening diameter in the second state>the opening diameter in the third state, and the third opening diameter of the second diaphragm can be set to an arbitrary size from the second state to the third state by the control from the body.
(5) In the projection image apparatus of (4), in a state where the projection lens unit is mounted on the projection image apparatus, the projection lens unit can set the opening diameter of the second diaphragm by mechanical operation control or electrical operation control from the body of the projection image apparatus.
(6) In the projection image apparatus of any one of (1) to (5), the first diaphragm of the illumination optical system includes a plurality of movable blades made of a material subjected to high thermal conduction and high reflection treatment, and a surface of the first diaphragm is a diffuse reflection surface.
(7) In the projection image apparatus of any one of (3) to (5), the second diaphragm of the projection lens unit includes a material subjected to light absorption treatment, and includes a plurality of movable blades.
(8) In the projection image apparatus of any one of (1) to (7), the illumination optical system includes afocal optical systems having different magnifications.
(9) In the projection image apparatus of (8), the afocal optical system provided in at least the optical path of the first color is different in magnification from the afocal optical systems provided in the optical paths of other colors.
(10) In the projection image apparatus of any one of (1) to (9), the laser light of the first color emitted from the light source is emitted in combination with the laser light of the first color emitted from each of the plurality of first light source components, and the interval between the centroid positions of the light fluxes from the plurality of first light source components is shorter than the interval formed by arranging the outer shapes of the respective first light source components in contact with each other in the interval direction.
(11) In the projection image apparatus of any one of (1) to (10), the laser light of the second color emitted from the light source is emitted in combination with the laser light of the second color emitted from each of the plurality of second light source components, and the interval between the centroid positions of the light fluxes from the plurality of second light source components is shorter than the interval formed by arranging the outer shapes of the respective second light source components in contact with each other in the interval direction.
(12) In the projection image apparatus of (2), the laser light of the third color emitted from the light source is emitted in combination with the laser light of the third color emitted from each of the plurality of third light source components, and the interval between the centroid positions of the light fluxes from the plurality of third light source components is shorter than the interval formed by arranging the outer shapes of the respective third light source components in contact with each other in the interval direction.

The present disclosure is applicable to a projection display device using laser light as a light source.

What is claimed is:

1. A projection image apparatus comprising:
a light source that emits laser light of a first color that is blue and laser light of a second color different from blue;
an illumination optical system that generates illumination light by combining the laser light of the first color and the laser light of the second color from the light source;
a light modulator that generates image light by modulating the illumination light from the illumination optical system in response to an image signal input from an outside; and
a projection optical system that enlarges the image light emitted from the light modulator and projects the image light onto a projection target,
wherein
the light source includes:
a first light source component including a plurality of first laser light emitters arranged in an array, and each configured to emit the laser light of the first color, and
a second light source component including a plurality of second laser light emitters arranged in an array, and each configured to emit the laser light of the second color,
an area of a light emitting surface of the first light source component is different from an area of a light emitting surface of the second light source component,
the illumination optical system includes a relay optical system that guides the illumination light to the light modulator,
the light source further includes an optical system that changes at least one of a height of a light source image of the laser light of the first color or a height of a light source image of the laser light of the second color,
the optical system of the light source is configured to have a small difference between the height of the light source image of the laser light of the first color and the height of the light source image of the laser light of the second color,
the relay optical system includes a first diaphragm of reflection type having a variable opening diameter, the first diaphragm disposed at a first pupil position where the illumination light is condensed, and
the projection optical system includes a second diaphragm of absorption type having a variable opening diameter, the second diaphragm disposed at a second pupil position conjugate with the first pupil position.

2. The projection image apparatus according to claim 1, wherein
the light source emits laser light of a third color different from the first color and the second color,
the illumination optical system generates the illumination light by combining the laser light of the first color, the laser light of the second color, and the laser light of the third color,
the light source further includes a third light source component including a plurality of third laser light emitters arranged in an array, and each configured to emit the laser light of the third color,
the area of the light emitting surface of the first light source component is different from an area of a light emitting surface of the third light source component,
the optical system of the light source changes a height of a light source image of the laser light of the third color, and
the optical system of the light source is configured to have a small difference between the height of the light source image of the laser light of the first color and the height of the light source image of the laser light of the third color.

3. The projection image apparatus according to claim 1, wherein
the projection optical system is a projection lens unit detachably attached to a body of the projection image apparatus,
the projection lens unit includes the second diaphragm,
in a case where the second diaphragm is not controlled from the outside, the second diaphragm is brought into a first state of being set to a first opening diameter,
in a case where the projection lens unit is mounted on a predetermined projector, the second diaphragm is brought into a second state of being set to a second opening diameter, and
the second diaphragm is configured to have the first opening diameter in the first state always larger than the second opening diameter in the second state.

4. The projection image apparatus according to claim 3, wherein
the second diaphragm is configured to be brought into a third state, from the second state, of being set to a third opening diameter smaller than the second opening diameter, and
the third opening diameter is set to an arbitrary size smaller than the second opening diameter under control of the body.

5. The projection image apparatus according to claim 4, wherein in a state where the projection lens unit is mounted on the projection image apparatus, an opening diameter of the second diaphragm is set by mechanical operation control or electrical operation control from the body of the projection image apparatus.

6. The projection image apparatus according to claim 1, wherein
the first diaphragm includes a plurality of movable blades, and
the plurality of movable blades mainly diffuse and reflect 70% or more of light incident on the plurality of movable blades.

7. The projection image apparatus according to claim 1, wherein
the second diaphragm includes a plurality of movable blades, and
the plurality of movable blades absorb 90% or more of visible light incident on the plurality of movable blades.

8. The projection image apparatus according to claim 1, wherein
the optical system of the light source includes:
a first afocal optical system that changes a height of the light source image of the laser light of the first color to a first height, and
a second afocal optical system that changes a height of the light source image of the laser light of the second color to a second height, and
the first afocal optical system and the second afocal optical system are configured to have a difference between the first height and the second height, the difference smaller than a difference between the height of the light source image of the laser light of the first color before entering the first afocal optical system and the height of the light source image of the laser light of the second color before entering the second afocal optical system.

9. The projection image apparatus according to claim 8, wherein
the illumination optical system further includes a dichroic mirror that combines the laser light of the first color and the laser light of the second color,
the first afocal optical system is disposed between the first light source component and the dichroic mirror, and
the second afocal optical system is disposed between the second light source component and the dichroic mirror.

10. The projection image apparatus according to claim 1, wherein
the optical system of the light source includes a first afocal optical system that changes a height of the light source image of the laser light of the first color to a first height, and
the first afocal optical system is configured to have a difference between the first height and the height of the light source image of the laser light of the second color, the difference smaller than a difference between the height of the light source image of the laser light of the first color before entering the first afocal optical system and the height of the light source image of the laser light of the second color.

11. The projection image apparatus according to claim 1, wherein
the optical system of the light source includes a second afocal optical system that changes a height of the light source image of the laser light of the second color to a second height, and
the second afocal optical system is configured to have a difference between the height of the light source image of the laser light of the first color and the second height, the difference smaller than a difference between the height of the light source image of the laser light of the first color and the height of the light source image of the laser light of the second color before entering the second afocal optical system.

12. The projection image apparatus according to claim 1, wherein
the light source includes:
a fourth light source component including a plurality of fourth laser light emitters arranged in an array, and each configured to emit the laser light of the first color,
a first mirror that reflects the laser light of the first color emitted from the first light source component, and
a fourth mirror that reflects the laser light of the first color emitted from the fourth light source component, and
an interval between a centroid position of a light flux of the laser light of the first color reflected by the first mirror and a centroid position of a light flux of the laser light of the first color reflected by the fourth mirror is shorter than an interval between a center position of the first light source component and a center position of the fourth light source component when an outer shape of the first light source component and an outer shape of the fourth light source component are arranged in contact with each other.

13. The projection image apparatus according to claim 1, wherein
the light source includes:
a fifth light source component including a plurality of fifth laser light emitters arranged in an array, and each configured to emit the laser light of the second color,
a second mirror that reflects the laser light of the second color emitted from the second light source component, and
a fifth mirror that reflects the laser light of the second color emitted from the fifth light source component, and
an interval between a centroid position of a light flux of the laser light of the second color reflected by the second mirror and a centroid position of a light flux of the laser light of the second color reflected by the fifth mirror is shorter than an interval between a center position of the second light source component and a center position of the fifth light source component when an outer shape of the second light source component and an outer shape of the fifth light source component are arranged in contact with each other.

14. The projection image apparatus according to claim 2, wherein
the light source includes:
a sixth light source component including a plurality of sixth laser light emitters arranged in an array, and each configured to emit the laser light of the third color,
a third mirror that reflects the laser light of the third color emitted from the third light source component, and
a sixth mirror that reflects the laser light of the third color emitted from the sixth light source component, and
an interval between a centroid position of a light flux of the laser light of the third color reflected by the third mirror and a centroid position of a light flux of the laser light of the third color reflected by the sixth mirror is shorter than an interval between a center position of the third light source component and a center position of the sixth light source component when an outer shape of the third light source component and an outer shape of the sixth light source component are arranged in contact with each other.

15. The projection image apparatus according to claim 2, wherein
the second color is green, and
the third color is red.

16. The projection image apparatus according to claim 1, wherein the area of the light emitting surface of the first light source component is smaller than the area of the light emitting surface of the second light source component.

17. The projection image apparatus according to claim 1, wherein the relay optical system further includes a lens that condenses the illumination light at the first pupil position.
